(19) United States
(12) Patent Application Publication
(10) Pub. No.: US 2024/0282220 A1
(43) Pub. Date: Aug. 22, 2024

(54) CATHETERIZATION TRAINING DEVICE

(71) Applicant: Christiana Care Health System, Inc., Wilmington, DE (US)

(72) Inventors: John Evans, Landenberg, PA (US); Jonathan Meade, Newark, DE (US)

(21) Appl. No.: 18/651,092

(22) Filed: Apr. 30, 2024

Related U.S. Application Data
(63) Continuation-in-part of application No. 18/425,833, filed on Jan. 29, 2024.
(60) Provisional application No. 63/469,934, filed on May 31, 2023.
(60) Provisional application No. 63/441,493, filed on Jan. 27, 2023.

(51) Int. Cl. G09B 23/30; G09B 5/06

(52) U.S. Cl. CPC G09B 23/303; G09B 5/06

(57) ABSTRACT

A “smart” urinary catheterization training device Includes sensors, electronics, etc. to allow clinicians to practice urinary catheterization procedures with instruction and/or feedback for training purposes. The device includes a human anatomy body model that defines a urinary bladder and a proximal urethra model. The device may include an actuator operable to impinge upon the proximal urethra model to provide varied simulation experiences with different levels of difficulty. The device may include a sensor operative to sense catheter presence and provide an output signal that is used to cause delivery of a haptic, audible or other signal to provide positive or negative feedback to the clinician. The device may include a smart glass display positioned to overlie the body model and display at least one of textual, graphical and visual instructions to guide a clinician in performing a catheterization procedure.

### CROSS-REFERENCE TO RELATED APPLICATION

This application is a continuation-in-part of U.S. patent application Ser. No. 18/425,833, filed Jan. 29, 2024, which claims the benefit of priority of U.S. provisional patent application No. 63/441,493, filed Jan. 27, 2023, and this application claims the benefit of priority of U.S. provisional patent application No. 63/246,934, filed May 31, 2023, the entire disclosures of each of which are hereby incorporated herein by reference.

### FIELD OF THE INVENTION

The present invention relates generally to training tools for healthcare providers, and more particularly to a catheterization training device including bodily tissue model structures and sensor-based training and feedback for teaching and practicing urinary catheterization procedures.

### DISCUSSION OF RELATED ART

There is a common need in healthcare for nurses and other medical/clinical healthcare providers to perform a urinary catheterization procedure on human patients. Medical/nursing students and other clinicians need to undergo training and learn such procedures before performing such procedures on human patients. Additionally, it has been recognized to be desirable for fully-qualified clinicians to be able to occasionally practice such procedures, e.g., immediately before performing such a procedure on a human patient, to ensure that such procedures are performed correctly.

Improper performance of a urinary catheterization procedure can result in various problems. For example, improper aseptic insertion of a urinary catheter during the urinary catheterization procedure can cause Catheter-Associated Urinary Tract Infections (CAUTIs). CAUTIs are a metric measured by healthcare organizations to assess patient care outcomes. The Centers for Medicare & Medicaid Services, The Joint Commission, and other regulators use this metric as well. Although providers are formally trained in the urinary catheterization procedure, the infrequency with which the procedure is performed can lead to a failure to meet applicable standards of care.

Some rudimentary training devices exist that include models of human body tissues. Many of such models typically include only one of male genitalia and female genitalia, despite the need to perform catheterizations on both males and females. Some such models include large-scale (e.g., life-size) human-form body models including a torso, legs and genitalia, typically made of silicone and plastic, that are large, heavy, bulky and difficult to store.

What is needed is a urinary catheterization training device that allows clinicians to practice/be trained on catheterization procedures with instructions and/or feedback to help ensure that procedures are performed correctly and that clinicians are trained adequately, thus reducing the risk of improperly-performed catheterization procedures, and associated patient infections.

### SUMMARY

The present invention provides a “smart” urinary catheterization training device that allows clinicians to practice/be trained in urinary catheterization procedures with instruction and/or feedback to help ensure that procedures are performed correctly and that clinicians are trained adequately. This reduces the risk of improperly-performed catheterization procedures, and associated patient infections. The “smart” urinary catheterization device includes sensors, electronics and/or other mechanisms that facilitate in the training of clinicians in urinary catheterization procedures by providing instructions and/or feedback to the clinician.

The smart urinary catheterization training device comprises a body model representative of human anatomy and defining at least a urinary bladder model and a proximal urethra model defining a first canal in fluid communication with said urinary bladder model.

In accordance with one aspect of the present invention, an exemplary smart urinary catheterization training device may further include an actuator disposed adjacent said proximal urethra model and operable to impinge upon a portion of said proximal urethra model; a motor operatively connected to said actuator; and a microcontroller operatively connected to said motor to control said motor to cause said actuator to selectively impinge upon said portion of said proximal urethra model. This may be used, for example, to provide varied simulation experiences with different levels of difficulty (e.g., in Novice, Intermediate and Expert training modes) and/or different training scenarios (such as a Normal Anatomy and Enlarged Prostate mode). In such embodiments, the motor may be controlled by the microcontroller to selectively drive the actuator to selectively impinge upon a portion of the urethra model so as to simulate an easy catheter insertion (e.g., no impingement) or a more difficult/enlarged prostate scenario (e.g., with impingement upon the urethra model so as to narrow the urethra and/or apply resistance to simulate a more difficult catheter insertion), as a function of the training mode selected by the user, accordingly to programming of the microcontroller. This provides valuable feedback to the clinician, in real-time during the catheterization process, that is useful in training the clinician.

In accordance with one aspect of the present invention, an exemplary smart urinary catheterization training device may further include a sensor positioned on said body model and operative to sense a presence of a catheter and provide an output signal; and a feedback system comprising: a feedback device; and a microcontroller operatively connected to said sensor and said feedback device to selectively provide a feedback signal in as a function of said output signal from said sensor. The feedback system is operable to create a feedback signal (e.g., a palpable vibration signal) as an instruction and/or haptic feedback to provide positive or negative feedback to the clinician, e.g., during the catheter insertion process. This provides valuable feedback to the clinician, in real-time during the catheterization process, that is useful in training the clinician.

In accordance with one aspect of the present invention, an exemplary smart urinary catheterization training device may further include a smart glass display positioned to overlie said body model; and a microcontroller operatively connected to said smart glass display to selectively cause display at least one of textual, graphical and visual instructions to guide a clinician in performing a catheterization procedure. The smart glass display may be controlled to display textual, graphical and/or visual instructions, e.g., in a step-wise fashion, to guide the clinician in performing a procedure in a step-wise fashion, and/or to provide feedback during a procedure, e.g., in response to sensed pressures, etc. In certain embodiments, the smart glass display may be controlled to provide visual overlays in the nature of an augmented reality display, with prompts to guide the clinician in performing a procedure in a step-wise fashion, and/or to provide feedback during a procedure, e.g., in response to sensed pressures, etc. By way of example, the smart glass display may be used to provide a more photorealistic image of a patient, relative to the leg and torso portions.

### BRIEF DESCRIPTION OF THE FIGURES

An understanding of the following description will be facilitated by reference to the attached drawings, in which:

FIG. 1 is a perspective view of an exemplary sensor-based catheterization training device in accordance an exemplary embodiment of the present invention;

FIG. 2 is a perspective view of an exemplary sensor-based

catheterization training device in accordance with another exemplary embodiment of the present invention; and

FIG. 3 is a schematic diagram of an exemplary system including a catheterization training device in accordance with the present invention;

FIGS. 4A-4E illustrate exemplary motor-driven compression and/or resistance mechanisms that can be caused to selectively adjust an amount of impingement upon the urethra model to simulate a more difficult catheter insertion;

FIG. 5 illustrates examples of sensors positioned within or near the bladder model to measure/detect catheter presence, location, force and the like;

FIG. 6 illustrates examples of sensors on internal urethra model tubing to measure/detect catheter presence, location, force, strain, and the like;

FIG. 7 illustrates exemplary smart glasses that may be controlled to display textual, graphical and/or visual instructions to guide the clinician in performing a procedure in a step-wise fashion, and/or to provide feedback during a procedure; and

FIG. 8 illustrates a smart glass overlay that may used to display textual, graphical and/or visual instructions to guide the clinician in performing a procedure in a step-wise fashion, and/or to provide feedback during a procedure.

### DETAILED DESCRIPTION

The present invention provides a “smart” urinary catheterization training device that allows clinicians to practice/be trained in urinary catheterization procedures with instruction and/or feedback to help ensure that procedures are performed correctly and that clinicians are trained adequately. This reduces the risk of improperly-performed catheterization procedures, and associated patient infections.

In accordance with the present invention, the urinary catheterization training device 100 is a “smart” device in that it includes sensors, electronics and/or other mechanisms that facilitate in the training of clinicians in urinary catheterization procedures by providing instructions and/or feedback to the clinician.

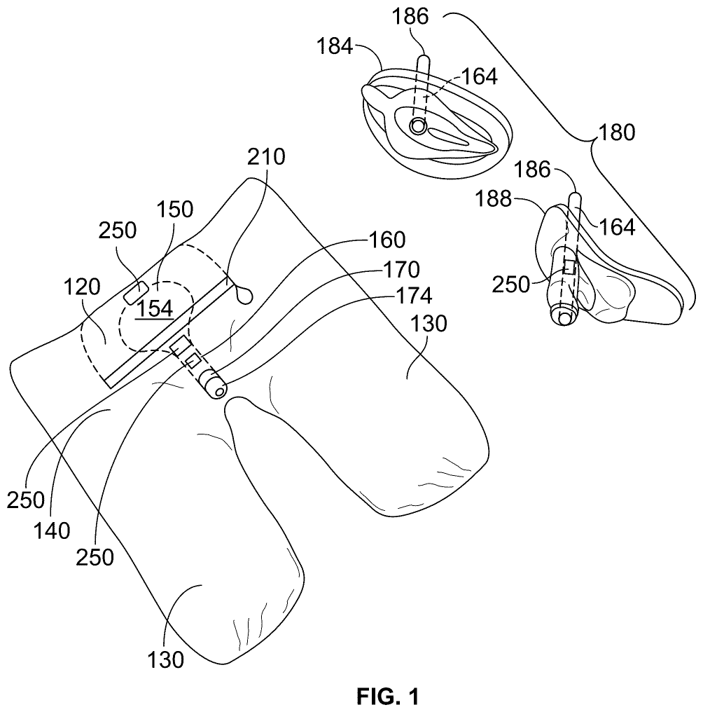

Referring now to FIG. 1, an exemplary “smart” urinary catheterization training device 100 is shown. This exemplary catheterization training device 100 includes partial leg 130 and/or partial torso 140 elements. The leg and torso elements 130, 140 house internal body tissue model structures relevant to a urinary catheterization procedure in anatomically correct positions. In particular, this includes at least a urinary bladder model 150 and at least a proximal portion 160 of a urethra model, which may be tube-like or otherwise define a urethral canal/conduit. The torso 140 (e.g., partial lower abdomen), and legs 130 (e.g., partial upper thighs) may be constructed of lightweight and soft/bendable/compressible materials. By way of examples, these structures may be formed of a readily-cleanable and reinforced fabric-type material (e.g., vinyl, polyethylene, or polypropylene fabric) stuffed with foam, polyester “wool” filling, or the like. This allows the device to be much lighter than conventional silicone/plastic-type body models. The material is preferably selected to be readily cleanable/sterilizable, e.g., by wiping the surface with an iodine-, alcohol-, or oil-based cleaning solution.

The leg/torso elements may include a mounting structure 170 for mounting thereto a detachable genitalia model structure accessory 180 in an anatomically correct position adjacent the juncture of the leg elements 130. The mounting structure 170 may further serves to ensure registration and alignment of the genitalia model structure accessory 180 in a predetermined position, to ensure registration and alignment of a distal portion 164 of a urethra model of the genitalia model structure accessory 180 with the proximal portion 160 of the urethra model of the leg/torso elements 130/140 (and the bladder 150) when mated thereto via the mounting structure 170 (and/or to a connector 174 at a terminal end of the proximal portion 160 of the urethra model), to ensure fluid communication therebetween.

In one embodiment, genitalia accessories 180 may include an interchangeable female genitalia model structure accessory 184 and male genitalia model structure accessory 188.

In a certain embodiment, the leg 130 and/or torso 140 elements define an internal cavity 200 that is closable by a closure 210. Positioned within the cavity are the bladder model 150 in fluid communication with a proximal portion 160 of the urethra model that terminates in the connector 174. The connector 174 is operable to form a mechanical interconnection with a corresponding connector 186 of the genitalia accessory and to form a fluid-tight interconnection therewith. Accordingly, when either the female genitalia model structure accessory 184 or male genitalia model structure accessory 188 is mated via its respective connector 186 to the connector 174, the proximal portion 160 and distal portion 164 of the urethra model are interconnected and in fluid communication with each other and with an internal cavity 154 of the bladder model 150.

Preferably, the bladder model 150 includes a substantially closed container (e.g., closed except for an outlet open to the proximal portion of the urethra model) that can be disassembled for cleaning or other access to the container, e.g., in the nature of a bottle body and a reclosable lid configured to form a fluid-tight seal therewith). Preferably, a bladder cavity defined by the container is substantially larger in cross-section than the cross-section of the outlet, at least immediately adjacent the outlet, to allow for expansion of the catheter (e.g., a “balloon” of a foley catheter as part of a typical catheterization procedure). The bladder cavity may define a volume comparable in size to a normal human bladder (e.g., in the range of approximately 350 ml-500 ml in volume). The connector may be permanently fixed to the proximal urethra model tubing structure associated with the leg/torso element. The connector may include structures to stabilize/attach the tubing structure to the leg/torso element by “sandwiching” the fabric between flanges on the connector. The genitalia accessories include a complementary mating structure and/or connector for forming a mechanical and fluid-tight seal with the connector, to form a continuous, fluid-tight urethral canal model through the genitalia accessories to the bladder.

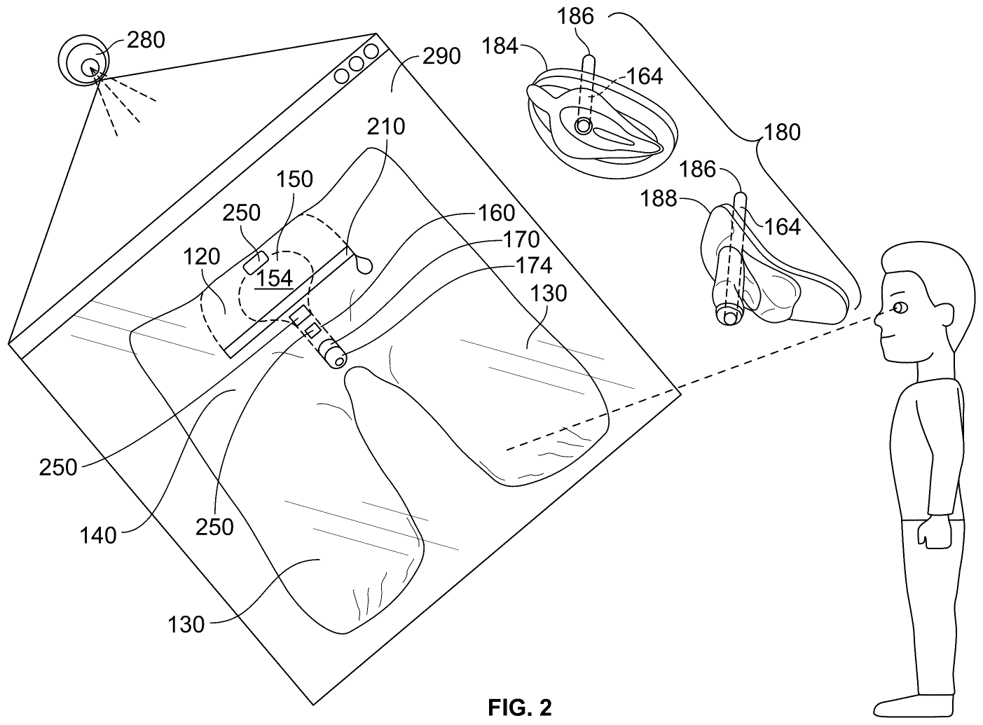

This exemplary urinary catheterization training device 100 is a “smart” device in that it includes an input device, such as a touchscreen display or a display screen 200 and user-operable input buttons 210a, 210b, 210c presenting options for selecting a training mode, as well as an embedded microcontroller 220 configured to control at least one motor 230, as will be appreciated from FIGS. 1 and 2.

By way of example, the user-selectable training modes may include different levels of difficulty (such as Novice, Intermediate and Expert modes) and/or different training scenarios (such as a Normal Anatomy and Enlarged Prostate mode). In such embodiments, the motor (such as a servo motor) may be controlled by the microcontroller to selectively drive an actuator 240 (such as a cam 242, or pump/hydraulics 244 or pump/pneumatics 246) to selectively impinge upon a portion of the urethra model so as to simulate an easy catheter insertion (e.g., no impingement) or a more difficult/enlarged prostate scenario (e.g., with impingement upon the urethra model so as to narrow the urethra and/or apply resistance to simulate a more difficult catheter insertion), as a function of the training mode selected by the user, accordingly to programming of the microcontroller 220. This provides valuable feedback to the clinician, in real-time during the catheterization process, that is useful in training the clinician.

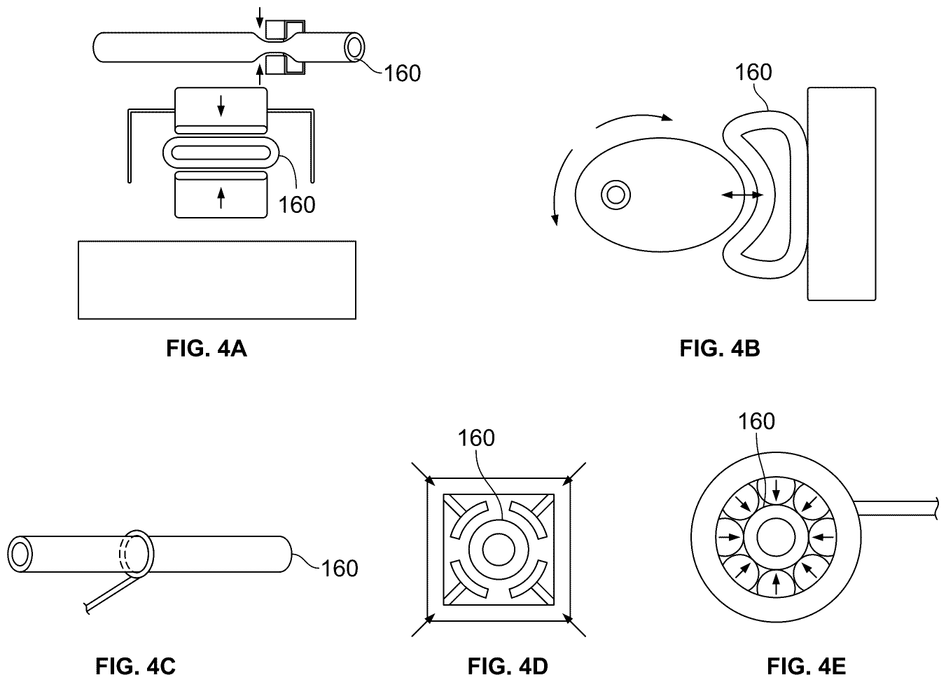

By way of example, FIGS. 4A-4E illustrate various exemplary motor-driven compression and/or resistance mechanisms that can be caused to selectively adjust an amount of impingement upon the urethra model so as to narrow the urethra and/or apply resistance to simulate a more difficult catheter insertion, e.g., in the Intermediate and/or Expert modes. For example, FIG. 4A illustrates a clamp that can be driven by the motor to exert force to compress a portion of tubing of the urethra model, FIG. 4B illustrates a cam that can be driven by the motor to exert force to compress a portion of tubing of the urethra model, FIG. 4C illustrates a snare-link compression band that can be drawn by the motor to cinch around and compress a portion of tubing of the urethra model, FIG. 4D illustrates external pressure plates that can be driven by the motor to squeeze a portion of tubing of the urethra model, and FIG. 4E illustrates a external bladder associated with a pump that can be driven by the motor to fill the bladder and cause the bladder to squeeze a portion of tubing of the urethra model.

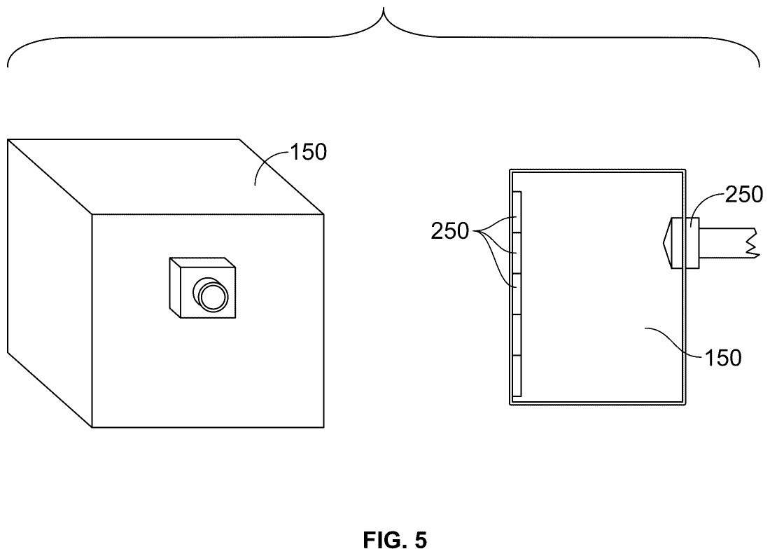

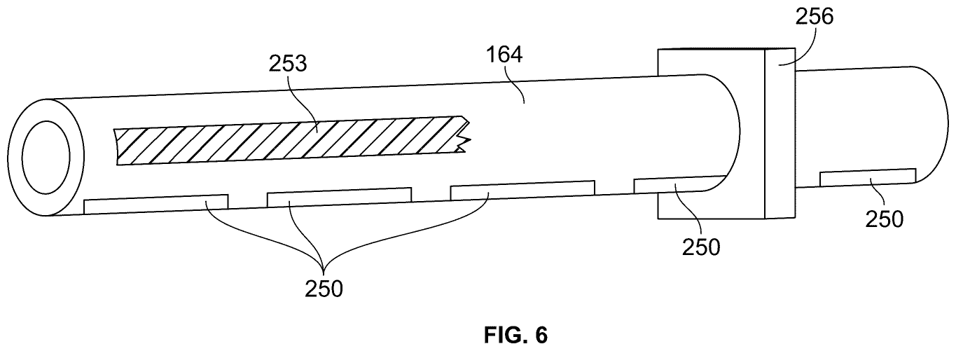

By way of additional example, the training device 100 may further include a feedback system for providing feedback to a user/clinician during use of the device. The feedback system includes a feedback device, such as a haptic feedback motor 245 (e.g., an additional motor) that may be controlled by the microcontroller 220 to selectively be driven to create a feedback signal (e.g., a palpable vibration signal) as an instruction and/or haptic feedback to provide positive or negative feedback to the clinician, e.g., during the catheter insertion process. In certain embodiments, the device 100 may include one or more sensors, such as pressure sensors 230 and/or proximity sensors (e.g., pressure-sensitive switches, photosensors, etc.) 235, configured to be operable to sense the presence of a catheter and provide an output signal, and the microcontroller 220 may be configured to drive the motor to provide haptic feedback to the clinician in response to the sensor's detection of the presence of the catheter (or in response to a sensed pressure above a threshold level) as reflected in the sensor's output signal. For example, referring now to FIGS. 1, 2 and 5, a sensor 250 (e.g., pressure sensor 230) may be provided on a proximal wall of the bladder, such that sensing of an inserted catheter at that location can be used to trigger haptic feedback to the clinician (by driving the vibration motor) to indicate that the catheter has been inserted too far, and would cause pain to a patient. By way of alternative example, a sensor 250 may be provided on at a junction of the urethra and the bladder, such that sensing of an inserted catheter at that location can be used to trigger haptic feedback to the clinician (by driving the vibration motor) to indicate that the catheter is about to enter the bladder. By way of further example, a sensor 250, such as a flex sensor 253 and/or a strain sensor 256, could be provided on a distal portion of the urethra model (e.g., to sense flex exceeding a threshold level that could indicate uncomfortable bending of the genitalia), or on a proximal portion of the urethra model (e.g., to sense flex associated with an insertion of the catheter that is too forceful or improperly lubricated and effectively “jamming” in the urethra model, as will be appreciated from FIG. 6. This provides valuable feedback to the clinician, in real-time during the catheterization process, that is useful in training the clinician.

By way of additional example, the feedback system of the training device 100 may further include a speaker 260, and the microcontroller may be configured to drive the speaker 260 to provide audible instruction and/or feedback to the user as a function of conditions sensed by the sensors 250. For example, rather than the haptic feedback described above, audible feedback could be provided in the form of a buzzer sound or other tone to provide positive or negative feedback, or pre-recorded sounds (e.g., groans) or pre-recorded speech (e.g., “Ouch!”). This provides valuable feedback to the clinician, in real-time during the catheterization process, that is useful in training the clinician.

By way of additional example, the training device 100 may further include various devices to provide visual instruction and/or feedback to the clinician, e.g., during the catheter insertion process.

In one such embodiment, textual and/or graphic instructions are provided to the clinician via the display screen 200, which may be controlled by the microcontroller 220 to provide suitable, e.g., step-by-step, instructions.

In another such embodiment, the training device 100 may further include LEDs or other light sources that are illuminated in a step-wise fashion to guide the clinician in performing a procedure in a step-wise fashion, and/or to provide feedback during a procedure, e.g., in response to sensed pressures, etc.

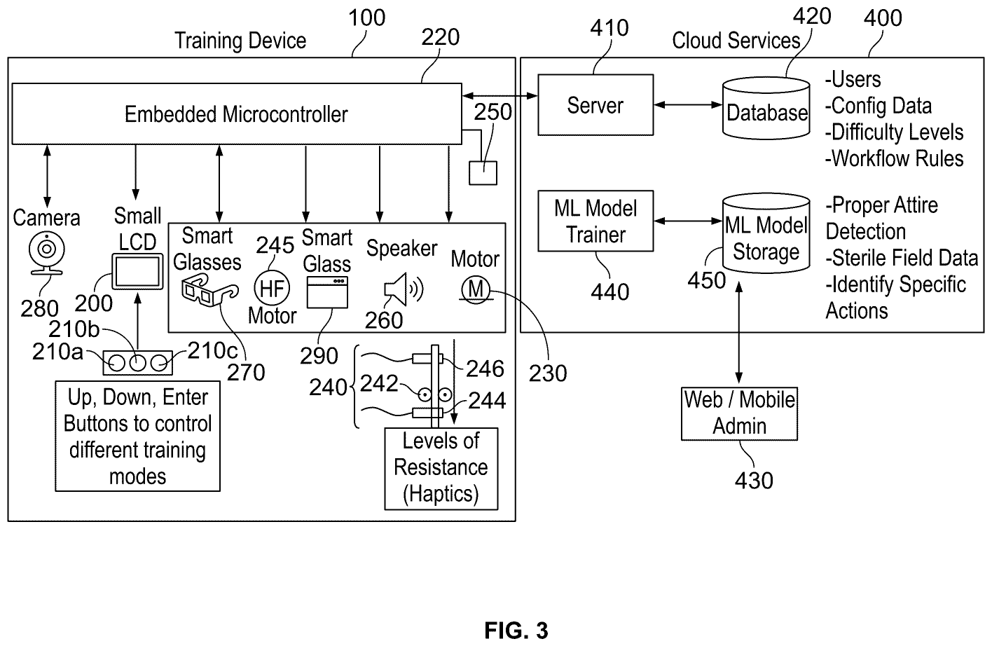

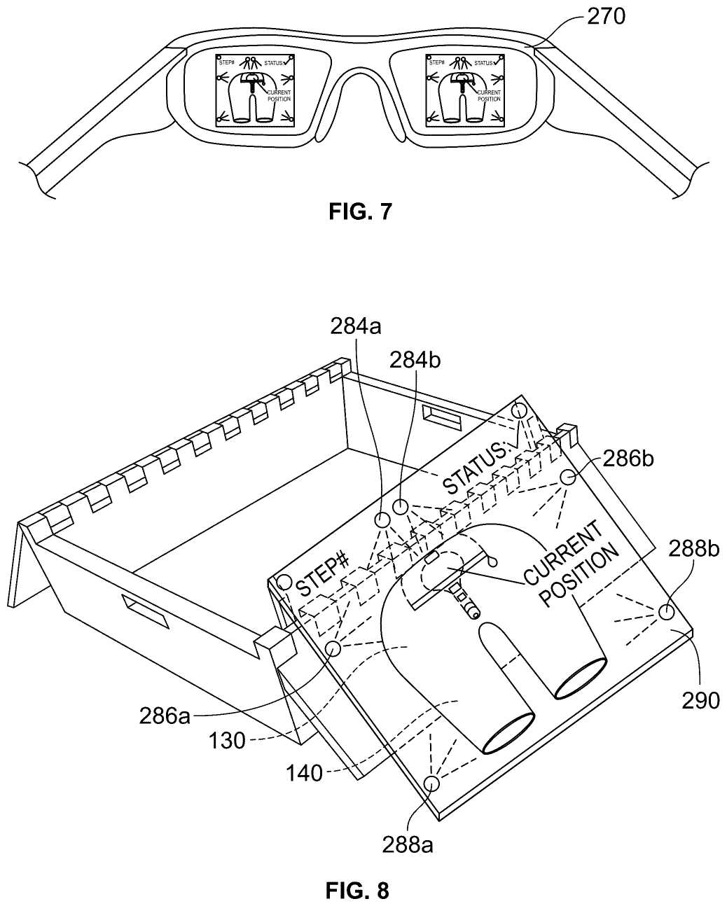

In yet another such embodiment, the training device 100 may further include smart glasses 270 in communication with the microcontroller 220. The smart glasses 270 may be controlled to display textual, graphical and/or visual instructions, e.g., in a step-wise fashion, to guide the clinician in performing a procedure in a step-wise fashion, and/or to provide feedback during a procedure, e.g., in response to sensed pressures, etc., as will be appreciated from FIGS. 3 and 7. In certain embodiments, the smart glasses 270 may be controlled to provide visual overlays in the nature of an augmented reality display, with prompts to guide the clinician in performing a procedure in a step-wise fashion, and/or to provide feedback during a procedure, e.g., in response to sensed pressures, etc.

In still another such embodiment, the training device 100 may further include an imaging device 280 (such as one or more digital cameras) and a smart glass display 290 in communication with the microcontroller 220. The smart glass display 290 may be disposed above the leg and torso portions 130, 140, and positionable between the leg and torso portions 130, 140 and the clinician, so the clinician can view the leg and torso portions 130, 140 through the smart glass display 290, as best shown in FIGS. 2 and 9. The smart display 290 may be controlled to display textual, graphical and/or visual instructions, e.g., in a step-wise fashion, to guide the clinician in performing a procedure in a step-wise fashion, and/or to provide feedback during a procedure, e.g., in response to sensed pressures, etc. In certain embodiments, the smart glass display 290 may be controlled to provide visual overlays in the nature of an augmented reality display, with prompts to guide the clinician in performing a procedure in a step-wise fashion, and/or to provide feedback during a procedure, e.g., in response to sensed pressures, etc. By way of example, the smart glass display may be used to provide a more photorealistic image of a patient, relative to the leg and torso portions 130, 140.

In certain embodiments, the imaging device 280 may include a pair of user-facing digital cameras 284a, 284b that are configured to provide for stereoscopic imaging, as shown in FIG. 8. The cameras 284a, 284b may be used for eye-tracking (to align a position of the visual overlay to the leg/torso model) and identification of a location/field of view to generate spatially accurate visual overlays for display via the smart glass display 290.

In certain embodiments, the imaging device 280 may further include at least one pair of leg/torso model-facing digital cameras 286a, 286b, 288a, 288b that are configured to provide for stereoscopic imaging, as shown in FIG. 8. The cameras 286a, 286b, 288a, 288b may be used for machine vision/monitoring of the catheterization process and environment (e.g., identifying user actions and tracking a sterile field). They may also be used in conjunction with the smart glass 290 and smart glasses 270 to generate spatially accurate visual overlays of the leg/torso model.

In certain embodiments, one or more of these cameras may be integrated into the smart glasses 270 for similar purposes.

Additionally, for example, the imaging device, along with computer vision/machine vision techniques may be used to interpret the field of view and monitor the clinician's actions. For example, the imaging device 280 may be used to identify a sterile region and a non-sterile region, to identify the catheter (and/or the clinicians' hands) and to monitor for actions that are inconsistent with maintaining a sterile environment and/or catheter, and provide feedback to the user if sterile conditions are violated. Additionally, the imaging device 280 may be used to monitor for proper catheterization procedures and provide feedback of proper procedures are not followed (e.g., failure to gown, failure to glove, failure to lubricate the catheter, etc.).

Additionally, the smart glass display 290 may be used to provide visual overlays in the nature of text, highlighted regions, directional prompts, etc., and may do so in visual alignment with the leg and torso portions 130, 140. For example, in a “novice mode” the prompts could describe the next step in the procedure or highlight a position of a catheter inside the model, whereas in an “intermediate mode” the smart glass(es) overlay could only display confirmation of past steps and positive or negative feedback as catheterization-related actions are performed.

The smart glass display 290 may also be used to enhance the catheterization training process, e.g., to display visual information simulation, such as displaying a simulation simulating a flow (“flash”) of urine from the bladder upon successful catheterization. These overlays can provide instructions prospectively, before catheterization steps and/or feedback retrospectively, after catheterization steps.

In certain embodiments, the device 100 may be configured to communicate with a computerized administration system 400 that may provide various functions. The administration system comprises a processor, a memory, and instructions stored in the memory and executable by the processor to identify a user profile of a clinician, and to store at least one of configuration data, training mode data, difficulty level data, prompt data, feedback data, and workflow rules, and procedure attempt and procedure completion data for each user profile as described herein.

For example, the device 100 may communicate, e.g., using a network communications device via a communications network, with a server 410 (remote computing system) and database 420 of the computerized administration system 400 that allows for tracking of clinical user profiles, configuration data (such as for simulation of various conditions), difficulty levels (such as settings for various training modes, e.g., with a greater or lesser degree of prompts, feedback, etc.), as well as workflow rules (such as instructions for each operational mode and/or catheterization process rules consistent with an acceptable standard of care, such as the CDC's catheter insertion guidelines).

Additionally, the administration system 400 may communicate (e.g., via a communications network) with a clinician's computing device, such as a software “app” running on a smartphone. Clinician accounts may be managed such that, for example, a particular clinician may log in to the system and see a record of past training modules completed, those not yet completed, earn badges/recognition/certification for completing training modules or sets of training modules, etc.

Additionally, the computerized administration system 400 may include a machine learning training module 440 and a machine learning model storage 450 so that, for example, the system can gather image data via the imaging device 280 and perform computer vision-related tasks, such as identifying proper clinician attire, detecting and monitoring a sterile field, and identify other specific actions, such as catheterization and/or procedure preparation steps, such as donning of gloves, proper tissue/equipment sterilization techniques, proper actions to maintain a sterile field, etc., and identify any actions that violate associates rules for proper procedures, and provide appropriate feedback (e.g., via a display during or after the procedure, in log of notes, etc.) to the clinician. By way of example, the camera 280 may capture an image stream of the leg/torso model and pass that to the embedded microcontroller 220. The image stream may then be transmitted to the server 410. The server 410/system may then use the machine learning model in storage 450 to determine a state of the model and user interaction. The result of the comparison will be passed back to the embedded microcontroller 220. Based on a current operational mode and the result of the comparison, notification may be given to clinician/user via speaker 260, motor 230, haptics 245, smart glass 290, and/or smart glasses 270.

The device 100 may be used to practice a urinary catheterization procedure as follows. First, the device 100 may be removed from a storage shelf or other storage area and place on a hospital bed, table or other work surface, or otherwise be set up (e.g., positioned beneath the smart glass 290), if needed.

To further prepare to practice the procedure, a genitalia accessory 180 may be mounted to the legs/torso 130, 140 using the connector 240 such that the genitalia accessory and leg/torso provides a continuous urethra model through the genitalia accessory to the bladder.

The clinician may then select a training program and/or training mode, e.g., using buttons 210a, 210b, 210c and/or otherwise providing input to the system via display 200.

In accordance with typical procedure, the clinician may then perform hand hygiene and don personal protective equipment (PPI), as appropriate. Next, the clinician may open the outer packaging of the catheter kit and place it in front of the torso/leg element, and open the inner packaging of the catheter kit. According to typical catheterization procedures, the clinician may then use the provided packet of castile soap wipes to cleanse the leg/torso element, discard gloves and perform hand hygiene with provided alcohol hand sanitizer gel. The clinician may then establish a sterile field by using proper aseptic technique, opening wrap, donning sterile gloves provided in the kit, and placing an underpad beneath leg/torso element, plastic or “shiny” side down, taking caution not to contaminate sterile gloves, and positioning a fenestrated drape on leg/torso element appropriately. Next, the clinician may prepare for catheter insertion by opening the iodine packet and pouring the solution onto foam swab sticks to saturate them, attach the water-filled syringe to the inflation port, and using a syringe to deposit lubricant into a tray, remove the Foley catheter from an outer wrap and place the catheter in the lubricant/tray, preparing the leg/torso element with iodine saturated foam swab sticks, using one swab stick for one swipe only and clean the labia/penis portion of the genitalia accessory. The clinician may then insert a distal end of the catheter through the distal portion of the urethra model of the genitalia accessory, and through the proximal portion of the urethra model into the bladder model. The clinician may then inflate the balloon with 10 mL water from a syringe and secure the Foley catheter to the leg/torso element.

Along the way, the clinician may be guided or prompted with instructions delivered via the LCD display, LEDs, speaker 260, smart glasses 270 and/or smart glass 290. Additionally, the clinician may be provided with feedback delivered via the LCD display 200, LEDs, motor 230, speaker 260, smart glasses 270 and/or smart glass 290.

The clinician's completion of the training, and/or conditions indicating success and/or failure as part of the training, may be communicated to the computerized administration system 400, and be recorded in the clinician's profile in the database 420, for further reference by the clinician or others, e.g., via the smartphone device 430.

After use of the device to practice the procedure (and after catheter insertion is complete, the clinician may clean the torso/leg element and reset the device 100 by deflating the catheter's balloon and withdrawing/removing the catheter from the bladder, leg-torso and genitalia accessory. The device may then be cleaned with professional disposable surface disinfectant super sani-cloth wipes containing isopropyl alcohol, including cleaning of the torso/leg element and male/female genitalia accessory.

The following detailed description of the invention contains many specifics for the purpose of illustration. Any one of ordinary skill in the art will appreciate that many variations and alterations to the following details are within scope of the invention. Accordingly, the following implementations of the invention are set forth without any loss of generality to, and without imposing limitations upon, the claimed invention.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A smart urinary catheterization training device comprising:
a body model representative of human anatomy and defining at least:
a urinary bladder model; and
a proximal urethra model defining a first canal in fluid communication with said urinary bladder model;
an actuator disposed adjacent said proximal urethra model and operable to impinge upon a portion of said proximal urethra model;
a motor operatively connected to said actuator; and
a microcontroller operatively connected to said motor to control said motor to cause said actuator to selectively impinge upon said portion of said proximal urethra model.

2. The smart urinary catheterization training device of claim 1, wherein said actuator comprises a motor and at least one of a clamp, a cam, a snare-link compression band, and a pressure plate operable to move between a first position, in which said cam impinges upon said portion of said proximal urethra model to at least partially obstruct said first canal, and a second position, in which said cam does not impinge upon said portion of said proximal urethra model.

3. The smart urinary catheterization training device of claim 1, wherein said actuator comprises a pump operable to move at least one of a hydraulic actuator and a pneumatic operator between a first position, in which said at least one of said hydraulic actuator and said pneumatic operator impinges upon said portion of said proximal urethra model to at least partially obstruct said first canal, and a second position, in which said hydraulic actuator and said pneumatic operator does not impinge upon said portion of said proximal urethra model.

4. The smart urinary catheterization training device of claim 1, wherein said actuator comprises a pump operable to control inflation of a bladder between a first state, in which said bladder impinges upon said portion of said proximal urethra model to at least partially obstruct said first canal, and a second state, in which said bladder does not impinge upon said portion of said proximal urethra model.

5. The smart urinary catheterization training device of claim 1, further comprising an input device comprising at least one user-operable button usable to provide input to select a training mode, said microcontroller being configured to control said motor as a function of a user-selected training mode.

6. The smart urinary catheterization training device of claim 5, wherein said input device comprises a touchscreen display, and said at least one user-operable button is displayed on said touchscreen display.

7. The smart urinary catheterization training device of claim 5, wherein said input device comprises a display, and said at least one user-operable button is separate from said display.

8. The smart urinary catheterization training device of claim 1, wherein said proximal urethra model terminates in a connector, said smart urinary catheterization training device further comprising:
at least one genitalia accessory having a configuration of one of human male and human female genitalia, said at least one genitalia accessory defining a distal urethra model comprising a second canal terminating in a corresponding connector, said corresponding connector being operable to form a mechanical interconnection with said connector of said proximal urethra model to form a fluid-tight interconnection therewith, and a continuous canal through said distal urethra model and said proximal urethra model and into said urinary bladder model.

9. A smart urinary catheterization training device comprising:
a body model representative of human anatomy and defining at least:
a urinary bladder model; and
a proximal urethra model defining a first canal in fluid communication with said urinary bladder model and terminating in a connector;
a sensor positioned on said body model and operative to sense a presence of a catheter and provide an output signal; and
a feedback system comprising:
a feedback device; and
a microcontroller operatively connected to said sensor and said feedback device to selectively provide a feedback signal in as a function of said output signal from said sensor.

10. The smart urinary catheterization training device of claim 9, wherein said sensor comprises at least one of a pressure sensor, a proximity sensor, a flex sensor, and a strain sensor.

11. The smart urinary catheterization training device of claim 9, wherein said sensor comprises at least one of a pressure-sensitive switch and a photosensor.

12. The smart urinary catheterization training device of claim 9, wherein said sensor is provided on a proximal wall of said urinary bladder model.

13. The smart urinary catheterization training device of claim 9, wherein said sensor is provided on at a junction of said proximal urethra model and said urinary bladder model.

14. The smart urinary catheterization training device of claim 9, wherein said sensor is provided on at least one of distal portion and a proximal portion of said proximal urethra model.

15. The smart urinary catheterization training device of claim 9, wherein said feedback device comprises a haptic feedback motor operable to produce said feedback signal as a palpable vibration signal.

16. The smart urinary catheterization training device of claim 9, wherein said feedback device comprises a speaker operable to produce said feedback signal as an audible signal.

17. The smart urinary catheterization training device of claim 16, wherein said feedback device comprises a display, and wherein said microcontroller is configured to provide catheterization procedure instructions via said speaker.

18. The smart urinary catheterization training device of claim 9, wherein said feedback device comprises a display, and wherein said microcontroller is configured to provide catheterization procedure instructions via said display.

19. The smart urinary catheterization training device of claim 9, wherein said feedback device comprises a plurality of light sources support on said body model, and wherein said microcontroller is configured to illuminate selected ones of said plurality of light sources in a step-wise fashion to guide a clinician in performing a catheterization procedure.

20. The smart urinary catheterization training device of claim 9, wherein said feedback device comprises smart glasses, said microcontroller being operatively connected to said smart glasses, said microcontroller being configured to selectively cause at display via said smart glasses of at least one of textual, graphical and/or visual instructions to guide a clinician in performing a catheterization procedure.

21. The smart urinary catheterization training device of claim 20, wherein said microcontroller is configured to control said smart glasses to provide a display of a visual overlay, in an augmented reality display, including prompts to guide the clinician in performing the catheterization procedure.

22. A smart urinary catheterization training device comprising:
a body model representative of human anatomy and defining at least:
a urinary bladder model; and
a proximal urethra model defining a first canal in fluid communication with said urinary bladder model and terminating in a connector;
a smart glass display positioned to overlie said body model; and
a microcontroller operatively connected to said smart glass display to selectively cause display at least one of textual, graphical and visual instructions to guide a clinician in performing a catheterization procedure.

23. The smart urinary catheterization training device of claim 22, wherein said microcontroller is configured to provide a display of a visual overlay, in an augmented reality display overlying and in registration with said body model, including prompts to guide the clinician in performing the catheterization procedure.

24. The smart urinary catheterization training device of claim 23, wherein said microcontroller is configured to provide a photorealistic display of a human body in registration with said body model as part of said visual overlay.

25. The smart urinary catheterization training device of claim 22, wherein said microcontroller is configured to display of said at least one of said textual, graphical and visual instructions in a step-wise fashion to guide the clinician in performing the catheterization procedure in the step-wise fashion.

26. The smart urinary catheterization training device of claim 22, further comprising a sensor operatively connected to said microcontroller and positioned on said body model and operative to sense a presence of a catheter and provide an output signal, wherein said microcontroller is configured to display said at least one of said textual, graphical and visual instructions as a function of said output signal.

27. The smart urinary catheterization training device of claim 22, further comprising an imaging device positioned to capture images of a region encompassing said body model and provide an image signal, wherein said microcontroller is configured to cause display of said at least one of textual, graphical and visual instructions to guide the clinician in performing the catheterization procedure as a function of said image signal.

28. The smart urinary catheterization training device of claim 27, wherein said imaging device comprises a pair of user-facing digital cameras configured to provide stereoscopic imaging, and wherein said microcontroller is configured to process images from said pair of user-facing digital cameras to perform eye-tracking and align its display of a visual overlay to the body model as a function of said eye-tracking.

29. The smart urinary catheterization training device of claim 27, wherein said imaging device comprises a pair of body model-facing digital cameras configured to provide stereoscopic imaging, and wherein said microcontroller is configured to process images from said pair of user-facing digital cameras to monitor the catheterization procedure.

30. The smart urinary catheterization training device of claim 29, wherein said imaging device comprises a pair of body model-facing digital cameras configured to provide stereoscopic imaging, and wherein said microcontroller is configured to process images from said pair of user-facing digital cameras, to identify sterile and non-sterile regions is associate with the body model, to monitor the catheterization procedure and identify any violations of a sterile field associated with the body model during the catheterization procedure, and to provide feedback to the clinician if a violation of the sterile field is identified.

31. The smart urinary catheterization training device of claim 29, wherein said imaging device comprises a pair of body model-facing digital cameras configured to provide stereoscopic imaging, and wherein said microcontroller is configured to process images from said pair of user-facing digital cameras, to identify sterile and non-sterile regions is associate with the body model, to monitor the catheterization procedure and identify any violations of a proper catheterization procedure, and to provide feedback to the clinician if a violation of the proper catheterization procedure is identified.

32. The smart urinary catheterization training device of claim 23, further comprising an administration system comprising a processor, a memory, and instructions stored in said memory and executable by said processor to identify a user profile of a clinician, and to store at least one of configuration data, training mode data, difficulty level data, prompt data, feedback data, and workflow rules, and procedure attempt and procedure completion data for each user profile.

33. The smart urinary catheterization training device of claim 32, further comprising a network communication device in communication with said microcontroller, and wherein said administration system is provided as a remote computing system remote from said body model, but in data communication with, said microcontroller via said network communication device.

34. The smart urinary catheterization training device of claim 32, further comprising:
an imaging device positioned to capture images of a region encompassing said body model and provide an image signal, wherein said microcontroller is configured to cause display of said at least one of textual, graphical and visual instructions to guide the clinician in performing the catheterization procedure as a function of said image signal; and
an administration system comprising a processor, a memory, a machine learning training module and machine learning model storage adapted to gather image data via said imaging device and use computer vision to determine a state of said body model and user interaction, and prompt action to be taken by said microcontroller.
